(19) United States
(12) Patent Application Publication
(10) Pub. No.: US 2002/0166361 A1
(43) Pub. Date: Nov. 14, 2002

(54) Functional testing of explosive gas detectors

(76) Inventors: James C. Wantz, Mesa, AZ (US); Leon Cooper, Malibu, CA (US)

Correspondence Address: Natan Epstein, Esq., Law Offices of Natan Epstein, Trident Center 9th Floor, 11377 West Olympic Boulevard, Los Angeles, CA, 90064-1683, US

(21) Appl. No.: 09/855,576

(22) Filed: May 14, 2001

(51) Int. Cl. G01N 27/00

(52) U.S. Cl. 73/1.06

(57) ABSTRACT

Explosive gas detectors are functionally tested by directing a brief aerosol spray discharge of a formulation selected to provide a visible spray discharge and from an aerosol dispenser pressurized with a hydrocarbon propellant. The propellant activates a properly functioning gas detector. The visible directional spray visually confirms delivery of propellant to the gas detector unit, so that a failure to activate is properly attributable to detector failure. A preferred formulation is one previously proven successful for the functional testing of electronic smoke detectors.

### BACKGROUND OF THE INVENTION

1. Field of the Invention

This invention relates to the detection of explosive gases in the environment and more particularly concerns the functional testing of explosive gas detector units.

2. State of the Prior Art

Explosive gases constitute a hazard wherever hydrocarbon gases are used or stored. This includes any home equipped with a natural gas cooking range, water heaters, or gas space heaters and furnaces, and especially homes, trailers and motor homes with gas cooking or heating appliances supplied from propane gas tanks in rural areas and installations which are supplied by the natural gas lines available in urban areas. Leaks in the gas supply lines and connector fittings can release the gas into a poorly vented interior space, where the heavier than air gas may accumulate. The hydrocarbon gas is flammable, and when mixed with air can form a highly explosive mixture which is easily ignited by an electric spark or open flame. For this reason it is now common practice to install explosive gas detectors in motor homes and other environments susceptible to such risks in order to provide early warning of gas accumulations

Explosive gas detector units are commercially available from several vendors, such as Nighthawk®. For example, an explosive gas detector unit is available from Nighthawk® as their Model No. KNCOEG-3 and labeled as a Combination Carbon Monoxide Explosive Gas Alarm. This unit is sensitive to and responds with an alarm signal to the presence of methane, propane and butane among still other hydrocarbon gases, as well as free hydrogen gas. Most explosive gas detector units sold for home use are of the catalytic type, which generally operate by sensing a change in electrical resistance in a catalytic sensor element in the presence of the target gas. The commercially available explosive gas detector units are typically equipped with a push button actuated test switch, which, when pressed actuates the alarm function of the detector unit. The test switch does not, however, verify the response of the catalytic gas sensor element to the presence of a hydrocarbon gas in the environment. Instead, the test switch only provides a limited test of the electronic alarm circuits of the detector unit and fails to provide a functional test of the gas detector unit. A need exists for a safe, convenient, reliable, cost effective method for functionally testing explosive gas detector installations.

### SUMMARY OF THE INVENTION

In response to the aforementioned need the present invention provides a method for functionally testing explosive gas detectors and in particular explosive gas detectors. The novel method comprises the steps of providing an aerosol dispenser having an aerosol dispensing nozzle and pressurized with a hydrocarbon propellant for dispensing a formulation selected to deliver a visible directional spray or mist which serves to confirm delivery of the mist and the propellant admixed therein to the explosive gas detector unit. A presently preferred formulation is one of the formulations previously proven successful for the functional testing of electronic smoke detectors. The hydrocarbon propellant may be selected from the group of butane, iso-butane and propane, or mixtures of the same. It is desirable that the spray formulation be selected to evaporate without substantial residue. The spray may be delivered as a brief discharge lasting from one to about three seconds, or as short a spray as will suffice to activate the explosive gas detector unit under test, with the dispensing nozzle positioned at a distance of approximately 8 to 15 inches from the detector unit under test.

The chemical composition of the formulation is not critical to this invention, so long as it does not interfere with the proper operation of the explosive gas detector and is not environmentally objectionable. In particular, it is desirable that the spray formulation be substantially inert or harmless with regard to the plastic housings and electrical and electronic components used in the gas detector units to be tested. Presently preferred spray formulations for this purpose include phthalates such as alkyl phthalates mentioned in U.S. Pat. No. 5,139,699 issued to Cooper, et al. on Aug. 18, 1992 and silicon derivatives such as phenyl trimethicone disclosed in U.S. Pat. No. 5,785,891 issued to Lim et al.. Still other formulations may be found suitable for the purposes here disclosed.

In a more general aspect the invention may be understood as a method for functionally testing an explosive gas detector, comprising the steps of providing an aerosol dispenser having an aerosol dispensing nozzle and pressurized with a propellant substance for dispensing a formulation as a visible directional spray, the propellant being selected for triggering an alarm response from the explosive gas detector under test; and delivering a visible directional spray of the formulation from the dispensing nozzle to the explosive gas detector under test, whereby the visible directional spray serves as a visual aid for directing spray at the explosive gas detector under test and to visually confirm delivery of the spray including the propellant substance to the explosive gas detector for triggering the alarm function and thus functionally testing the explosive gas detector. In this general form of the invention the propellant substance preferably comprises a hydrocarbon gas such as butane, iso-butane and propane, or mixtures thereof.

### DETAILED DESCRIPTION OF THE PREFERRED EMBODIMENTS

This invention provides a safe and convenient method for functionally testing explosive gas detectors, particularly of the catalytic type, using spray formulations developed for functionally testing electronic smoke detectors. Existing formulations for testing electronic smoke detectors are generally chosen such that, when the formulation is discharged in spray form from an aerosol or spray dispenser pressurized with a propellant through a spray nozzle, the resulting spray is effective in activating or triggering the alarm function of both photoelectric and ionization types of smoke detectors by simulating the presence of air borne particulates characteristic of early stage combustion products. A number of smoke detector test spray formulations have been patented and found successful commercial use. The choice of the formulation is not critical to the method of the present invention except insofar as the formulation's environmental acceptability and its compatibility with materials such as plastics, metals etc., found in the explosive gas detector units to be tested according to this invention. Thus, the formulation should be chosen to be relatively inert with respect to thermoplastics, wiring, and electronic components. Typical propellants used for pressurizing the smoke detector test spray dispensers are liquefied hydrocarbon gases such as iso-butane and propane, among other possible hydrocarbon gases.

For purposes of testing electronic smoke detectors it is the formulation and its aerosol which operates as the active ingredient to trigger the alarm function of the smoke detector, while the hydrocarbon propellant generally may serve no purpose other than to eject the formulation from the dispenser as a directional discharge in spray or aerosol form. The pressurized spray dispenser used to deliver the spray discharge may be a conventional hand held spray can equipped with a finger operated spray nozzle. Reusable, rechargeable spray dispensers are also available and may be used for purposes of this invention.

For purposes of testing explosive gas detectors units, on the other hand, it is the propellant which acts to trigger the alarm response of the explosive gas detector, while the spray provides visual guidance and confirmation of delivery of the spray including the propellant substance to the explosive gas detector for functionally testing the explosive gas detector. It is not sufficient to rely upon activation of the audible or visible alarm signal of the explosive gas detector unit, since an inoperative detector will not deliver an alarm signal and the person testing the unit would not know whether the failure to elicit an alarm signal from the unit is due to failure of the explosive gas detector unit or because of his or her failure to sufficiently deliver the test spray to the explosive gas detector unit. The propellant substance alone is colorless and may be largely invisible when discharged from an aerosol or spray dispenser. However, a spray discharge of the smoke detector test formulation does provide a more readily visible and directional spray which is helpful for aiming the nozzle of the aerosol or spray dispenser toward the explosive gas detector unit under test, and also to visually confirm that the spray discharge does reach the explosive gas detector unit, thus providing assurance that propellant material also reaches the explosive gas detector unit. Having thus visually confirmed delivery of the propellant to the explosive gas detector unit under test, the user is able to rule out non-delivery of propellant as a cause for a failure to activate the explosive gas detector's alarm function and thus more confidently diagnose the explosive gas detector unit as defective. In practice, it has been found that a short duration spray discharge of between 1 and about 3 seconds, and in most cases only 1 or 2 seconds, delivered to an explosive gas detector unit of the catalytic type such as the aforementioned Nighthawk unit from a distance of about 8 to 15 inches, will suffice to activate the alarm function of the explosive gas detector unit.

The use of a formulation previously found to be acceptable for testing of electronic smoke detector units reasonably ensures that the spray or aerosol of this formulation has been found to be harmless to detector housings and electronics of smoke detectors, and thus can be safely applied to explosive gas detector units as well.

In a broader sense the method of this invention may extend to the functional testing of electronic detectors of any hazardous environmental contaminant by providing a spray dispenser having a spray dispensing nozzle and pressurized with a propellant substance and including a non-propellant substance such as a formulation which is expelled from the spray dispenser as a directional spray discharge more readily visible than the propellant alone, the propellant being selected for triggering an alarm response of the hazardous contaminant detector unit under test while the non-propellant formulation is largely inoperative for triggering such an alarm response, such that by delivering a visible directional spray of the formulation from the dispensing nozzle to the detector unit under test the visible directional spray serves as a visual aid for directing the spray at the detector unit under test and thereby to visually confirm delivery of the spray including the propellant substance to the detector unit for triggering the detector unit's alarm function, resulting in a functional test of the detector unit. The propellant substance may be a flammable or explosive gas such as butane, iso-butane or propane hydrocarbon gas, or mixtures thereof, and the more visible non-propellant formulation component of the directional spray discharge is desirably chosen to be substantially harmless to the detector unit.

What is claimed as new is:

1. A method for functionally testing explosive gas detectors of the catalytic type comprising the steps of:
providing an aerosol dispenser having an aerosol dispensing nozzle and pressurized with a hydrocarbon propellant for dispensing a spray formulation selected for actuating smoke detectors of both photoelectric and ionization types; and
delivering a spray of said formulation from said dispensing nozzle to the explosive gas detector under test.

2. The method of claim 1 wherein said hydrocarbon propellant is selected from the group of butane, iso-butane and propane.

3. The method of claim 1 wherein said aerosol dispenser and said spray formulation are selected to deliver said spray formulation in the form of a visible directional spray.

4. The method of claim 1 wherein said step of delivering comprises the step of delivering a spray discharge lasting from one to about three seconds.

5. The method of claim 1 wherein said step of delivering comprises the step of delivering a spray discharge with said dispensing nozzle positioned at a distance of about 8 to 15 inches from the detector under test.

6. The method of claim 1 wherein said spray formulation includes a trimethicone compound.

7. The method of claim 1 wherein said spray formulation includes a phthalate compound.

8. A method for functionally testing a explosive gas detector, comprising the steps of:
providing an aerosol dispenser having an aerosol dispensing nozzle and pressurized with an invisible propellant substance for dispensing a visible directional spray of formulation, said propellant being selected for triggering an alarm response from a said explosive gas detector under test; and
delivering a visible directional spray of said formulation from said dispensing nozzle to the explosive gas detector under test, whereby said visible directional spray serves as a visual aid for directing spray at the explosive gas detector under test and to visually confirm delivery of the spray including said propellant substance to the explosive gas detector for triggering and thus functionally testing the explosive gas detector.

9. The method of claim 8 wherein said propellant substance comprises a flammable or explosive gas.

10. The method of claim 8 wherein said propellant substance is a hydrocarbon gas.

11. The method of claim 10 wherein said hydrocarbon gas is selected from the group of butane, iso-butane, propane and mixtures thereof.
